(19) United States
(12) Patent Application Publication
(10) Pub. No.: US 2010/0020877 A1
(43) Pub. Date: Jan. 28, 2010

(54) MULTIPLE REFERENCE FRAME MOTION ESTIMATION IN VIDEO CODING

(75) Inventors: Oscar Chi Lim Au, Hong Kong (CN); Man Cheung Kung, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/178,337

(22) Filed: Jul. 23, 2008

(51) Int. Cl. H04N 11/02

(52) U.S. Cl. 375/240.16; 375/E07.076

(57) ABSTRACT

Multiple reference frame motion estimation for video frame blocks is provided. A plurality of copies of a block list of a reference frame can be loaded into texture memory. Encoding of video blocks of the video frame can be ordered to allow concurrent encoding of the video blocks. Furthermore, motion vector prediction can be performed concurrently for independent video blocks, the motion vectors can be related to each one of the plurality of copies of the block list of the reference frame and determined for the at least a portion of the plurality of blocks ordered for concurrent encoding. Additionally, a fast motion estimation algorithm can be concurrently performed on a number of video blocks to search surrounding blocks and compute motion vectors. Further, concurrent processing of multiple slices can be performed. Such concurrent processes can leverage the parallel architecture of at least one graphical processing unit.

### TECHNICAL FIELD

The following description relates generally to digital video coding, and more particularly to techniques for motion estimation.

### BACKGROUND

The evolution of computers and networking technologies has increased the need and desire for digital storage and transmission of audio and video signals on computers and/or other electronic devices. For example, computer users can play/record audio and video on personal computers. To facilitate this technology, audio/video signals can be encoded into one or more digital formats. Personal computers can be used to digitally encode signals from audio/video capture devices, such as video cameras, digital cameras, audio recorders, and the like. Further, such audio/video capture devices can encode signals for storage on a digital medium. Digitally stored and encoded signals can be decoded for playback on a computer or other electronic device. Encoders/decoders can use a variety of formats to achieve digital archival, editing, and playback, including the Moving Picture Experts Group (MPEG) formats (MPEG-1, MPEG-2, MPEG-4, etc.), and the like.

Additionally, digital signals can be transmitted between devices over a computer network. For example, utilizing a computer and high-speed network (e.g., digital subscriber line (DSL), cable, T1/T3, etc.) computer users can access and/or stream digital video content on systems across the world. Since the available bandwidth for such streaming is typically not as large as local access of media within a computer, and because processing power is ever-increasing at lower costs, encoders/decoders usually require more processing during encoding/decoding steps to decrease the amount of bandwidth required to transmit digital signals.

Accordingly, encoding/decoding methods have been developed, such as motion estimation, to provide block (e.g., pixel or region) prediction based on a previous reference frame—thus reducing the amount of block information transmitted since only the block prediction need be encoded for transmission. For example, motion vector prediction and early termination are used in some implementations to achieve fast motion estimation. These methods, however, can introduce peak signal to noise ratio loss. Moreover, the methods for motion estimation and video coding are usually computationally expensive, and introduce recurrent dependency among adjacent blocks during encoding.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Efficient inter-frame motion estimation is provided that mitigates adjacent block (e.g., pixel or regions of pixels) dependency in video frames by rearranging block encoding order and utilizing a fast motion estimation algorithm for determining motion vectors. Additionally, at least a portion of the motion estimation can be performed on a graphics processing unit (GPU) to achieve a high-degree of parallelism. Thus, selecting a block encoding order that removes adjacent block dependency can allow the parallel architecture of the GPU to synchronously encode a number of blocks of a video frame—increasing encoding efficiency. Moreover, a fast motion estimation algorithm can be performed for encoding the blocks by leveraging the GPU. Further, multiple reference frame motion estimation can be performed by loading duplicate block lists of a reference frame into texture memory to facilitate parallel processing—in this way, the same block of a video frame can be searched over different reference frames. In addition, a video frame can be separated into at multiple slices to create multiple block lists including a plurality of blocks. These block lists can be combined to facilitate parallel processing of multiple slices.

For example, an encoding determination for a block in motion estimation can require motion vector information with respect to adjacent blocks of a video frame, such as calculating a motion vector predictor as a median of a number of adjacent block motion vectors. Therefore, ordering encoding of blocks, such that blocks independent of each other can be concurrently encoded following encoding of required adjacent blocks, allows for advantageous utilization of parallel processing. Such parallel processing can be performed via a GPU parallel architecture, for example. Additionally, in one example, a multiple step search algorithm can be performed to locate an optimal motion vector for motion estimation using the GPU to concurrently search for potentially matched blocks or pixels between a current block and a reference block. Moreover, such parallel processing can be further facilitated by performing multiple reference frame motion estimation and/or by combining block lists created by slicing a video frame and parallel processing the combined block lists.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that estimates motion in parallel for encoding video, in accordance with an embodiment of the invention.

FIG. 2 illustrates a block diagram of an exemplary system that orders video blocks for concurrent encoding, in accordance with an embodiment of the invention.

FIG. 3 illustrates an example portion of a video frame ordered for concurrent decoding of a portion of the video blocks, in accordance with an embodiment of the invention.

FIG. 4 illustrates a block diagram of an exemplary system that utilizes inference to estimate motion and/or encode video, in accordance with an embodiment of the invention.

FIG. 5 illustrates an exemplary flow chart for ordering video blocks for concurrent encoding, in accordance with an embodiment of the invention.

FIG. 6 illustrates an exemplary flow chart for concurrently predicting motion vectors for disparate video blocks, in accordance with an embodiment of the invention.

FIG. 7 illustrates an exemplary flow chart for concurrently performing fast motion estimation over disparate video blocks, in accordance with an embodiment of the invention.

FIG. 8 illustrates a block diagram of an exemplary system that performs multiple reference frame motion estimation, in accordance with an embodiment of the invention.

FIG. 9 illustrates an exemplary flow chart for performing multiple reference frame motion estimation, in accordance with an embodiment of the invention.

FIG. 10 illustrates an exemplary flow chart for combining block lists created by slicing a video frame, in accordance with an embodiment of the invention.

FIG. 11 illustrates an example portion of a video frame comprised of block lists created by slicing the video frame, in accordance with an embodiment of the invention.

FIG. 12 is a schematic block diagram illustrating a suitable operating environment, in accordance with an embodiment of the invention.

FIG. 13 is a schematic block diagram of a sample-computing environment, in accordance with an embodiment of the invention.

### DETAILED DESCRIPTION

Parallel block video encoding using fast motion estimation is provided, in which independent blocks of pixels or regions can be concurrently encoded based on, at least in part, adjacent previously encoded blocks using motion estimation and/or motion vector prediction. In one example, parallel processing functionality of a graphics processing unit (GPU) can be leveraged to effectuate the concurrent encoding. Moreover, fast motion estimation algorithms, such as a multiple-step search algorithm, can be utilized for efficient motion vector determination of given blocks. In addition, the multiple-step search algorithm can be performed using the GPU for parallel processing. Further, parallel processing can be facilitated by utilizing duplicate block lists of a reference frame loaded into texture memory, allowing the same block of a video frame to be searched over different reference frames. In addition, block lists crated by slicing a video frame can be combined to facilitate parallel processing of multiple slices.

For example, the blocks of a video frame, which can be one or more pixels or regions of pixels of varying size, can be ordered for encoding to ensure that requisite adjacent blocks for calculating a motion vector predictor have been encoded (the motion vector predictor is equivalent to the median or mean average motion vector based on a number of adjacent blocks). Moreover, blocks ordered with the same number are independent of each other for encoding purposes, allowing similarly ordered blocks to be encoded concurrently.

Furthermore, the motion estimation encoding process can utilize a three step search (TSS) type of algorithm to determine the motion vector, based on comparison with a number of reference blocks. It is to be appreciated that a modified TSS algorithm can be used in addition to the TSS algorithm or in its alternative, such as a four-step search, five-step search (FSS), six-step search (SSS), etc. A cost can be computed as to decoding the motion vector or a residue between the motion vector and the predictor, and the video block can be accordingly encoded. Further, the minimum cost between blocks of different reference frames loaded into texture memory can be computed.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

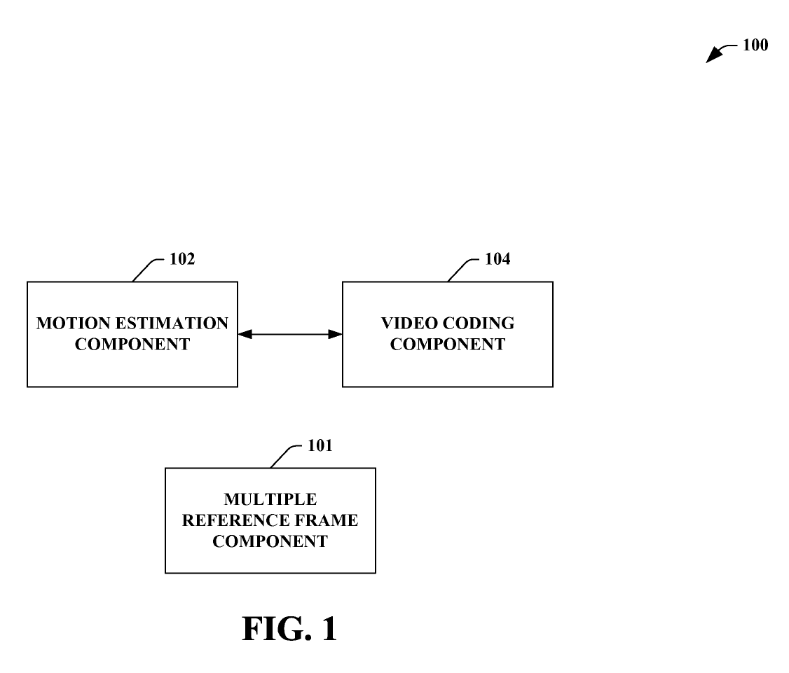

Now turning to the figures, FIG. 1 illustrates a system 100 that facilitates estimating motion for digitally encoding video, in accordance with an embodiment of the invention. Multiple reference frame component 101 can load a plurality of copies of a block list of a reference frame into texture memory. Motion estimation component 102 can concurrently determine motion vectors related to each copy of the plurality of copies of the block list of the reference frame to predict a video block based on, at least in part, a motion vector and video coding component 104, which can encode video to a digital format, based on, at least in part, the predicted video block. It is to be appreciated that a block can be, for example, a pixel, a collection of pixels, a region of pixels (of fixed or variable size), or substantially any portion of a video frame.

For example, upon receiving a frame or block for encoding, multiple reference frame component 101 can load a plurality of copies of a block list of a reference frame into texture memory. Motion estimation component 102 can evaluate the plurality of copies of the block list of the reference frame to predict the current video block or frame such that only a motion vector and/or related information need be encoded. Video coding component 104 can encode a motion vector for the video block, which can be predicted or computed for subsequent decoding based on, at least in part, motion vectors of surrounding video blocks. In another example, video coding component 104 can encode a residue between the motion vector and a predicted motion vector, which can be an average (e.g., median, mean, etc.) of one or more motion vectors for adjacent blocks. In either case, the vector or residue information related to a block is substantially smaller than information for each pixel of the block; thus, bandwidth can be saved at the expense of processing power by encoding the vector or residue. This can be at least partially accomplished by using the H.264/advanced video coding (AVC) standard or other motion picture experts group (MPEG) standard, for instance.

In one example, a video frame can be separated into a number of video blocks by video coding component 104 (or motion estimation component 102) for encoding using motion estimation. Moreover, the blocks can be ordered by video coding component 104 for encoding, so that the encoding can be concurrently performed for given independent blocks. In this regard, a parallel processor can be utilized by motion estimation component 102 to search video blocks for determining motion vectors based on the plurality of copies of the block list of the reference frame —increasing efficiency in the prediction and therefore the encoding. For example, a graphics processing unit (GPU) can have a parallel architecture, and thus, can be utilized for general purpose computing (GPGPU). It is to be appreciated that substantially any motion estimation algorithm can be utilized by motion estimation component 102 to determine motion vectors including, but not limited to, step searches, full searches, and/or the like.

Moreover, motion vectors of surrounding blocks can be utilized to create a motion vector predictor, and to estimate cost of encoding residue between the predictor and the motion vector of a current block. Thus, video coding component 104 can order blocks to ensure requisite blocks are appropriately encoded for computing the motion vector predictor. Additionally, by utilizing the GPU, video coding component 104 can encode the video block in parallel, according to the motion vector and the plurality of copies of the block list of the reference frame. Parallelizing these steps of motion estimation can significantly decrease processing time for encoding video according to a motion estimation algorithm. It is to be appreciated that motion estimation component 102 and/or video coding component 104 can leverage, or be implemented within, a GPU or other processor, in separate processors, and/or the like.

In addition, motion estimation component 102, video coding component 104, component functions, and/or processors implementing component functions can be integrated into devices utilized in video editing and/or playback. For example, such devices can be utilized in signal broadcasting technologies, storage technologies, conversational services (such as networking technologies, etc.), media streaming, and/or messaging services to provide efficient encoding/decoding of video —minimizing transmission bandwidth. Further, more emphasis can be placed on local processing power (e.g., one or more central processing units (CPU) or GPUs) to accommodate lower bandwidth capabilities. Further, appropriate processors can be utilized, such as a GPGPU, to efficiently encode video.

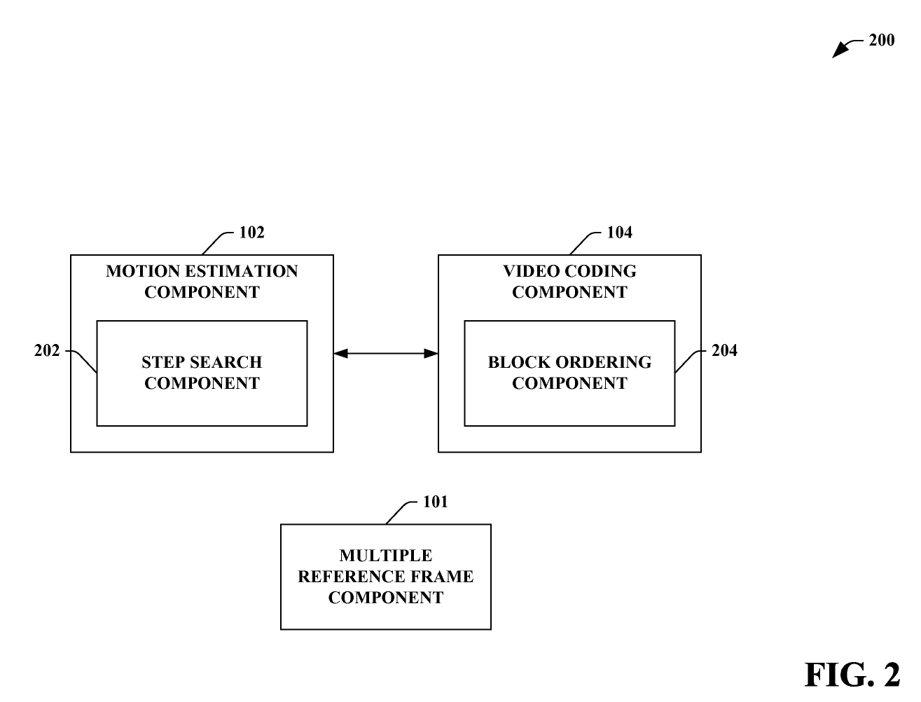

Referring to FIG. 2, a system 200 for providing efficient inter-frame video coding by mitigating block dependency is shown, in accordance with an embodiment of the invention. Multiple reference frame component 101 can load a plurality of copies of a block list of a reference frame into texture memory. Motion estimation component 102 can determine and/or predict motion vectors and/or related residue for video blocks. Video coding component 104 can encode frames or blocks of the video blocks (e.g., as vector or residue information) for transmission and/or subsequent decoding. Motion estimation component 102 can include step search component 202 that can perform a multiple-step search for a given video block, determining a motion vector from a previous reference block. Additionally, video coding component 104 can include block ordering component 204 that can specify an order of encoding of blocks of a given video frame. As mentioned, the order specified by block ordering component 204 can allow parallel encoding of independent video blocks.

For example, step search component 202 can determine motion vectors for video blocks based on the plurality of copies of the block list of the reference frame loaded into texture memory. Step search component 202 can perform a multiple-step search, for a video block to be encoded, by evaluating the video block with respect to a set of reference blocks of a previous video reference frame. For example, the block to be encoded can be compared to a similarly positioned block of the reference image as well as additional surrounding blocks. In typical step searches, for example, blocks at eight, substantially equidistant positions from the similarly positioned block in the reference frame can be evaluated as well. Typically, the substantially equidistant positions are at located at four corners and located at midpoints at four edges of a search window. One or more of the nine total blocks can become a next focal point in which eight surrounding, but nearer in proximity, video blocks can be successively evaluated in determining an associated minimum cost for coding the motion vector.

Step search component 202 can iteratively evaluate a video block based on a lowest cost until the video block is evaluated with respect to immediately surrounding blocks. Thus, the range chosen for the step search algorithm can influence the number of steps necessary to determine an appropriate motion vector associated with a minimum cost. For example, FSS can allow up to a 16 block search window from each direction from the video block, and SSS can allow up to a 32 block search; thus, for a given number of steps n, a 2ⁿ pixel search window can be utilized. It is to be appreciated that the search can be performed, for example, over variable lengths or sizes of blocks or pixels. Furthermore, a similar step search of substantially any degree can be utilized in this regard, or a completely different fast motion estimation algorithm, such as a full search, can be used by step search component 202. It is important to note that many other possible example searches can be utilized.

In addition, block ordering component 204 can order the video blocks of a frame so that the frame can be encoded in parallel. For example, blocks that do not depend from the other blocks can be encoded at the same time. In one embodiment, video coding component 104 can evaluate motion vectors of surrounding blocks to calculate a motion vector predictor for the current block being encoded and can estimate a cost of coding a motion vector residue between the determined motion vector and the motion vector predictor. Thus, the blocks can be ordered by block ordering component 204 such that requisite blocks for calculating the motion vector predictor for a given block are first encoded by video coding component 104. Additionally, blocks that are independent of one another can be encoded by video coding component 104 at the same time.

In one example, the cost of coding the residue can be calculated using the following Lagrangian cost function,

J(m,λ)=D(C,P(m))+λ(R(m−p)),

where C is the original video signal, P is the reference video signal, m is the current motion vector, p is the motion vector predictor for the current block (e.g., a median of surrounding motion vectors), and λ is the Lagrange multiplier, which can be quantization parameter (QP) independent. Moreover, R(x) represents bits used to encode motion information; D(x) can be a sum of absolute differences (SAD) between the original video signal and the reference video signal or SAD of Hadamard-transformed coefficients (SATD). A motion vector can be selected by video coding component 104 to minimize the cost computed by the foregoing function. It is to be appreciated that other cost functions can be used as well.

Additionally, the cost of coding the motion vector can be compared with a cost of encoding a residue motion vector related to the difference of a predicted motion vector and the actual motion vector, and the resulting encoding can depend on the calculated cost. Further, it is to be appreciated that the fast motion estimation algorithm chosen by step search component 202 can be different for given video blocks. Moreover, the functionalities provided by step search component 202 and/or block ordering component 204, as well as predicting motion vectors, can leverage, or be implemented within, a GPU having parallel architecture, providing further efficiency. Further, such implementation can be applied to multiple reference frame motion estimation and decoding of independent block lists resulting from multiple slices, as described herein.

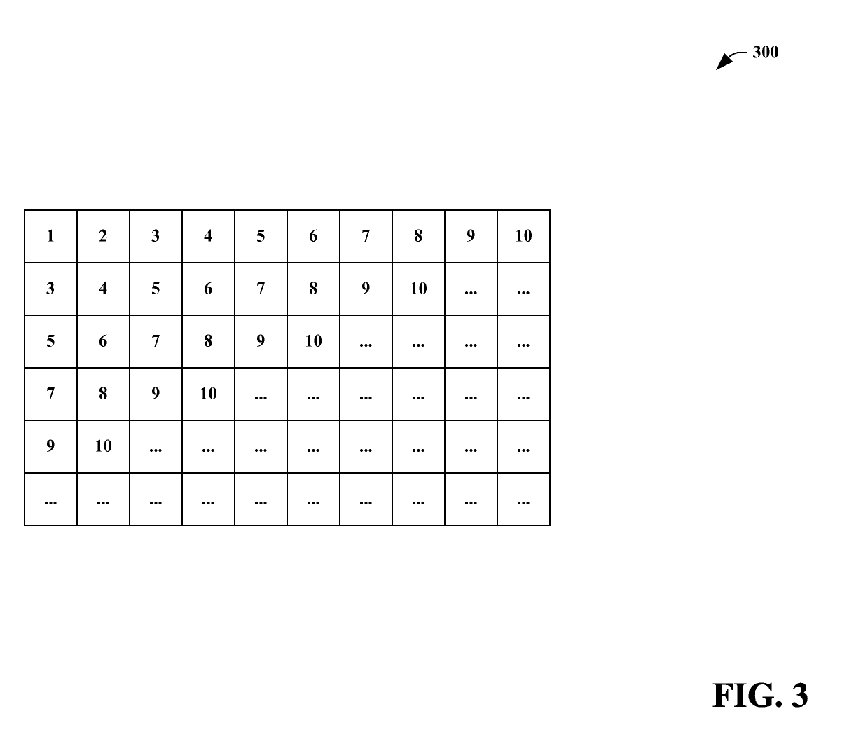

Turning now to FIG. 3, an example portion of a video frame 300 divided into ordered blocks to facilitate parallel encoding of the blocks is illustrated, in accordance with an embodiment of the invention. The blocks shown can be of varying pixel sizes, and a given block can be of a different pixel size than another block. The blocks can be square (e.g., n×n pixels) or rectangular (e.g., n×m pixels, where n and m are different integers). In one embodiment, the blocks can have a varying number of pixels in a given row or column, as compared to other rows or columns. In the illustrated example, for a given video block, the immediately surrounding blocks (e.g., an eight block square surrounding the video block) that are lower in number can be utilized in motion vector prediction as explained previously. Thus, for a block numbered 7, one or more of the surrounding blocks numbered 4, 5, or 6 can be utilized to predict the motion vector. Additionally, as no block numbered 7 is adjacent to another block numbered 7, substantially all blocks numbered 7 can be encoded in parallel as there is no dependency between the blocks.

In one example, some coding standards, such as H.264/AVC, utilize the block immediately left of the current block as well as the block immediately above the current block, and the block immediately to the upper right of the current block, to predict the motion vector for the current block. Thus, for blocks numbered 7, blocks labeled 4, 5, and 6 can be utilized to predict a motion vector for the blocks numbered 7. Because blocks labeled 4, 5, and 6 are lower in number, they are already encoded as motion vectors and can be averaged to produce the predicted motion vector for a given block 7. The blocks of the example video frame portion 300 can be encoded from top left to bottom right in this regard, and a parallel processor, such as a GPU or other processor, can be utilized to concurrently encode like-numbered blocks, rendering the encoding more efficient compared to the case in which all blocks depend from one another.

It is to be appreciated that the blocks can be ordered in substantially any way according to the algorithm being utilized. For example, the aforementioned ordering can be reversed starting at the bottom right and working to the top left, etc. Moreover, it is to be appreciated that portions of a video frame can be encoded in parallel by one or more GPUs or other processors as well. Thus, the video frame portion 300 can be one of many portions, or macro blocks, of a larger video frame, which can be encoded using the mechanisms explained above in parallel with other portions, for example. Furthermore, as described, the encoding for each video block can be performed using substantially any fast motion estimation algorithm, such as a multiple-step search (e.g., TSS, FSS, SSS, or substantially any number of steps), a full search, and/or the like to estimate a best motion vector for the given video block. Subsequently, the cost of encoding the motion vector or a residue between the motion vector and the predicted motion vector can be weighed in evaluating encoding costs.

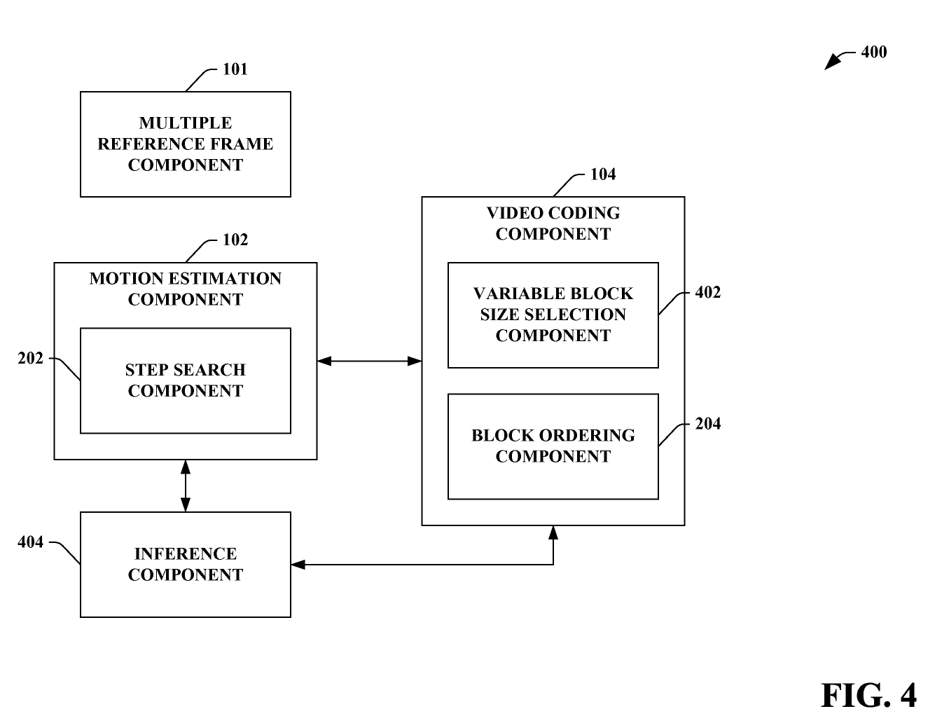

FIG. 4 illustrates a block diagram of an exemplary system that utilizes inference to estimate motion and/or encode video, in accordance with an embodiment of the invention. Multiple reference frame component 101 can load a plurality of copies of a block list of a reference frame into texture memory. Motion estimation component 102 can determine a video block based on, at least in part, a motion vector and an encoding via video coding component 104. Motion estimation component 102 can include step search component 202 that can determine a motion vector for a video block, or portion thereof, based at least in part on the plurality of copies of the block list of the reference frame, as previously described. Video coding component 104 can include block ordering component 204 that can order video block encoding to allow independent blocks to be encoded in parallel. Further, video coding component 104 can include variable block size selection component 402 that can specify one or more block sizes for video blocks of a video frame to be encoded. Furthermore, inference component 404 can infer one or more aspects related to encoding the video blocks.

In one example, video coding component 104 can utilize variable block size selection component 402 to separate a given video frame into one or more video blocks. As described above, the blocks can be square or can have a different number of pixels in given rows or columns of the block. Further, the blocks can be single pixels or portions thereof. Moreover, the blocks can be of varying size throughout the video frame. In one example, the video blocks are 4 pixels by 4 pixels. Additionally, the blocks can be grouped into sets of macro blocks, in one example. Inference component 404 can be utilized by variable block size selection component 402 to determine an optimal size for one or more blocks or macro blocks of the video frame. The inference can be made based at least in part on previous encodings (within the same or different video), CPU/GPU ability, bandwidth requirements, video size, etc.

In addition, the video blocks can be ordered by block ordering component 204. As described, the ordering can relate to preserving ability to encode one or more video blocks in parallel. Again, inference component 404 can infer such an order based at least in part on a desired encoding scheme or direction (e.g., top left to bottom right, etc.), type of processor being utilized, resources available to the processor, bandwidth requirements, video size, previous orderings, and/or the like. Furthermore, step search component 202 can leverage inference component 404 to select a fast motion estimation algorithm to utilize for determining one or more motion vectors related to a give video block. For example, the inference can be made as described above, depending on a previous algorithm, processing ability or requirements, time requirements, size requirements, bandwidth available, etc. Additionally, inference component 404 can make inferences based on factors such as encoding format/application, suspected decoding device or capabilities thereof, storage format and location, available resources, etc., for the above-mentioned components. Inference component 404 can also determine location or other metrics regarding a motion vector and the like.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further, one or more components and/or sub-components may be combined into a single component to provide aggregate functionality. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components can automate certain mechanisms or processes performed thereby to make portions of the systems and methods more adaptive, as well as efficient and intelligent, by inferring actions based on contextual information. By way of example and not limitation, such mechanisms can be employed with respect to generation of materialized views and the like.

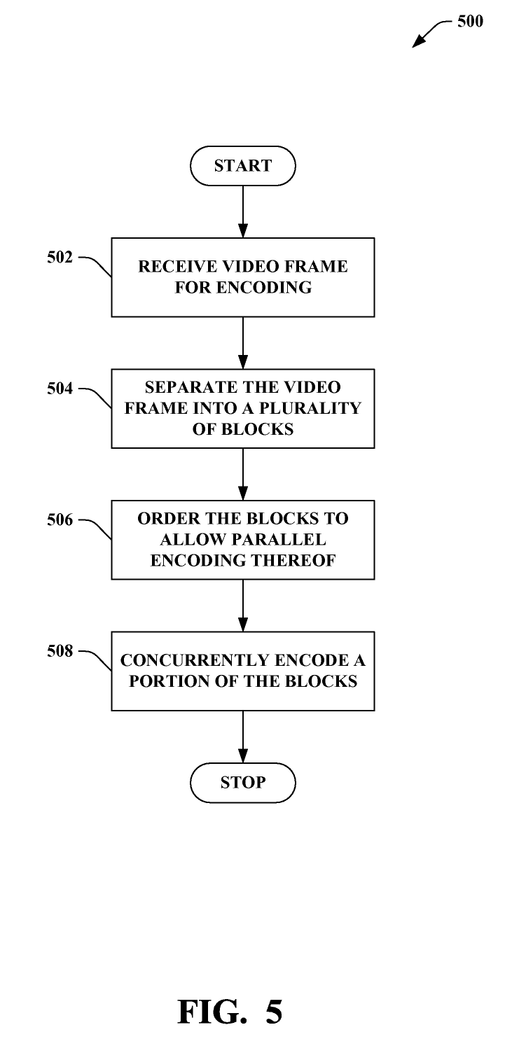

In view of the exemplary systems described supra, methodologies that may be implemented in accordance with the disclosed subject matter will be better appreciated with reference to the flow charts of FIGS. 5-7 and 9-10. While for purposes of simplicity of explanation the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 shows a methodology 500 for concurrent motion estimation of video blocks related to a reference frame and ordering video blocks for concurrent encoding thereof, in accordance with an embodiment of the invention. At 502, a video frame is received for encoding. For example, the video frame can be encoded as one or more motion vectors related to a reference frame as described. The video frame can be one of a plurality of frames of a video signal. At 504, the video frame can be separated into a plurality of video blocks to allow diverse encoding thereof. As described previously, the blocks can be of substantially any size, and can vary among the blocks. In one example, the blocks can be n pixels by m pixels, where n and m can be the same or different integers.

At 506, the blocks can be ordered to allow parallel encoding thereof. As described, depending on a motion estimation algorithm, blocks utilized for estimating or predicting motion vectors for a current block can be encoded before the current block. However, the blocks can be ordered such that blocks can be encoded in parallel as shown supra. It is to be appreciated that the blocks can be ordered in substantially any manner to achieve this end—the examples shown above are for the purpose of illustrating possible schemes. At 508, a portion of the blocks can be concurrently encoded according to the imposed order. In one embodiment, this can be performed via a GPU.

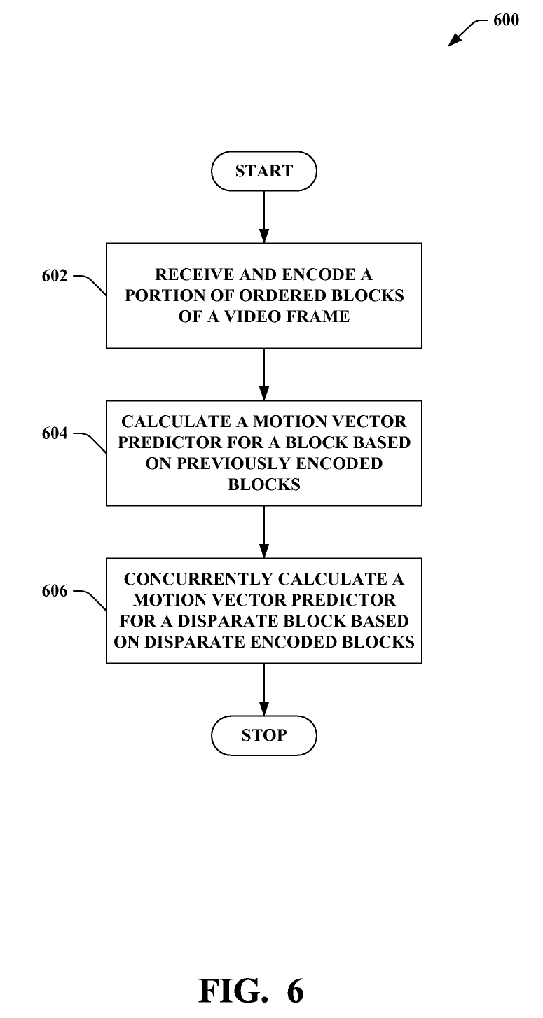

FIG. 6 illustrates a methodology 600 that facilitates concurrently calculating motion vector predictors for a number of video blocks of a given frame, in accordance with an embodiment of the invention. At 602, a portion of ordered blocks of a video frame are received; the blocks can be ordered as described previously, for example, to allow parallel encoding thereof. At 604, a motion vector predictor can be calculated for a block based on previously encoded blocks. In one example, the motion vector can be predicted based at least in part on evaluating one or more adjacent video blocks.

In H.264/AVC, the blocks immediately left, to the top, and to the top right of the current block are used for predicting motion vectors. For instance, as described, the blocks can be ordered such that blocks needed to calculate the motion vector predictor can be encoded before the current block. Additionally, blocks not needed for such calculations can be similarly ordered such that they can be encoded in parallel. At 606, a motion vector predictor for such a block is concurrently calculated using differently encoded blocks. Thus, removing dependency between blocks allows for concurrent encoding or motion vector prediction—facilitating increased coding efficiency and system performance.

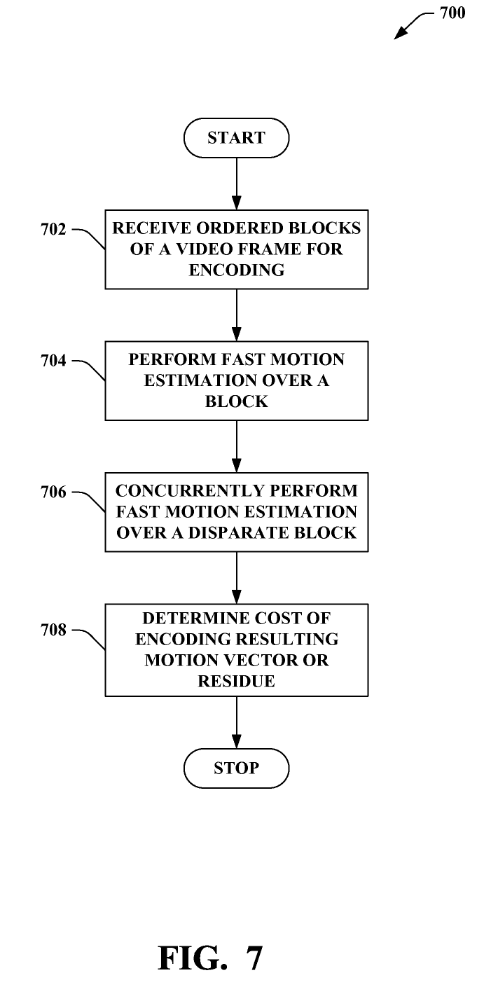

FIG. 7 shows a methodology 700 for concurrently performing fast motion estimation on a plurality of video blocks of a video frame. At 702, ordered blocks of a video frame are received for encoding; the blocks can be ordered as described above to allow concurrent encoding or motion vector prediction. At 704, fast motion estimation can be performed over a block. This can be any motion estimation algorithm such as a step search (e.g., TSS, FSS, SSS, and/or substantially any number as described), a full search, and/or the like. At 706, fast motion estimation can be performed concurrently over a disparate block. In one embodiment, a disparate motion estimation algorithm can be utilized for the disparate block. At 708, a cost of encoding the resulting motion vector or a residue related to the predicted motion vector can be determined. Depending on the cost(s), the video block can be accordingly encoded.

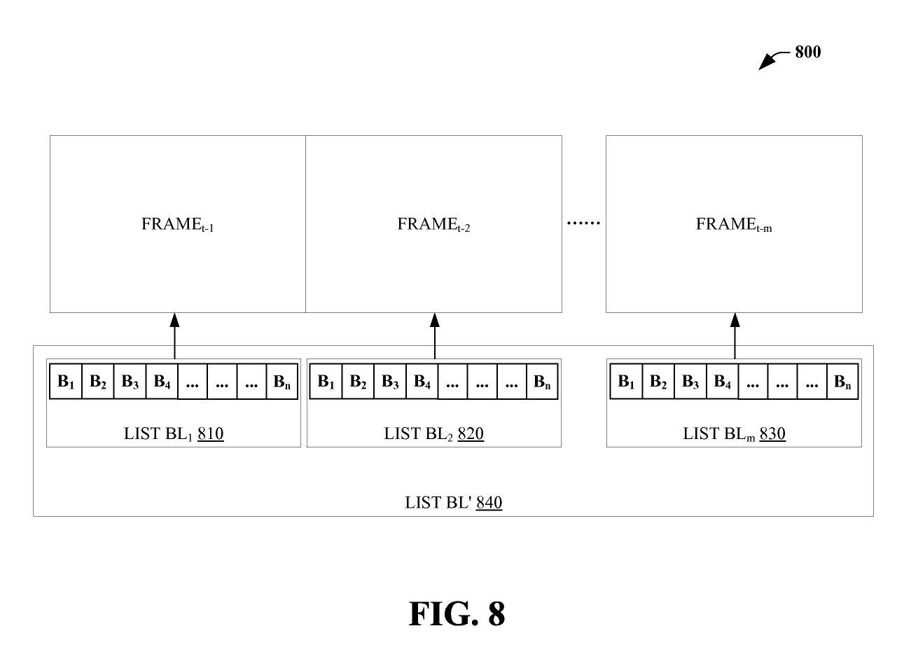

FIG. 8 illustrates a block diagram of an exemplary system 800 that performs multiple reference frame motion estimation, in accordance with an embodiment of the invention. In system 800, reference frames can be loaded into texture memory and reused for multiple reference frame motion estimation (MRF-ME). In one embodiment, each reference frame can include a block list (BL) of size n 4×4 blocks (e.g., B₁ to Bₙ). It should be appreciated that a block list can include a size n of any dimensioned blocks (e.g., 8×8, 16×16, 4×8, etc.). All blocks within a block list can be searched within their respective frame. For example, blocks B₁ to Bₙ of BL₁ 810 can be searched on FRAME_{T-1}, and blocks B₁ to Bₙ of BL₂ 820 can be searched on FRAME_{T-2}. M duplicate block lists containing blocks B₁ to Bₙ can be created by copying a block list (e.g., BL₁ 810) multiple times to texture memory—thus creating a new block list BL′ 840 with size n*m. By searching duplicate block lists of a reference frame by utilizing texture memory, parallel processing can be facilitated.

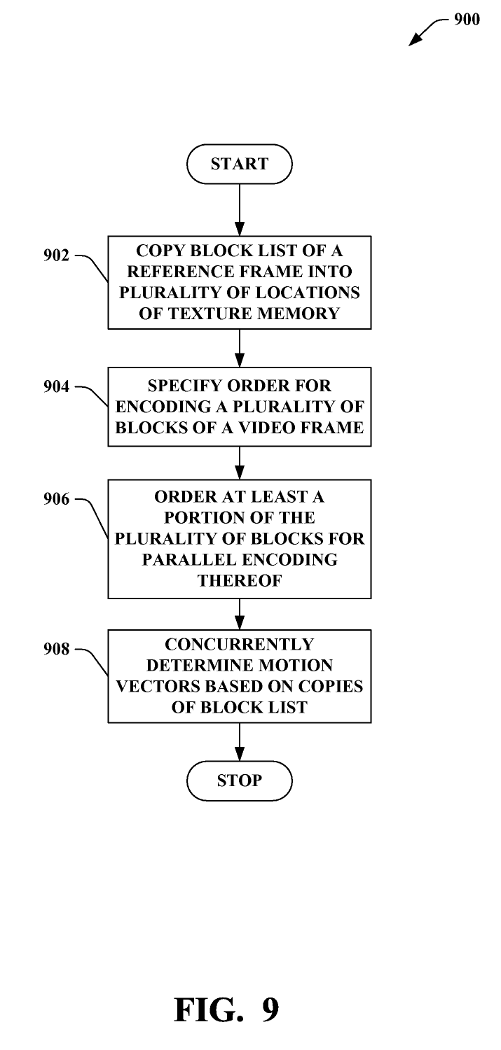

FIG. 9 illustrates an exemplary flow chart 900 for performing multiple reference frame motion estimation, in accordance with an embodiment of the invention. At 902, a multiple reference frame component can load a plurality of copies of a block list of a reference frame into texture memory. At 904, block ordering component 204 can specify an order for encoding the plurality of blocks of a video frame. At least a portion of the plurality of blocks can be ordered for concurrent encoding at 906. At 908, motion estimation component 102 can concurrently determine motion vectors related to the each one of the plurality of copies of the block list of the reference frame, the motion vectors determined for the at least portion of the plurality of blocks of the video frame.

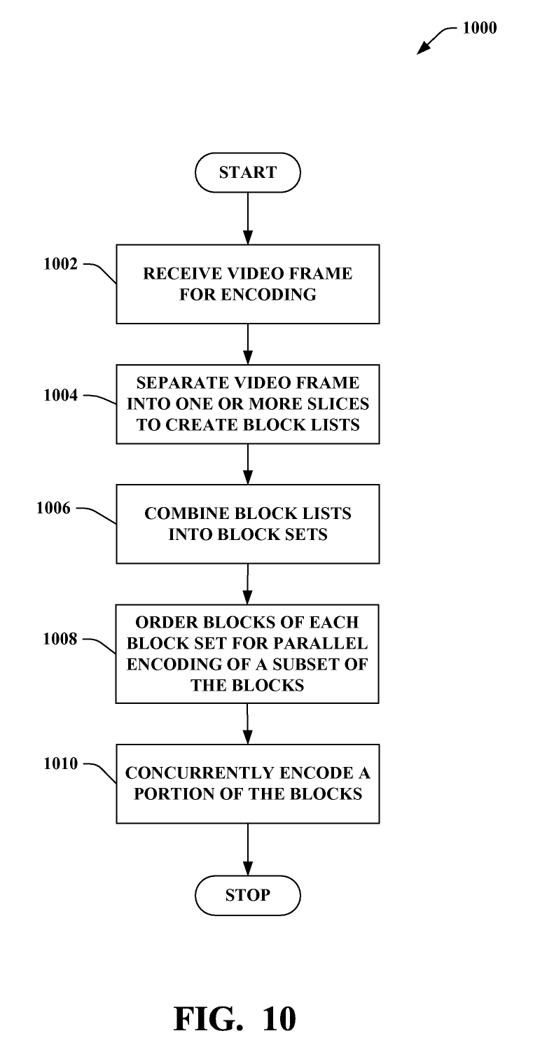

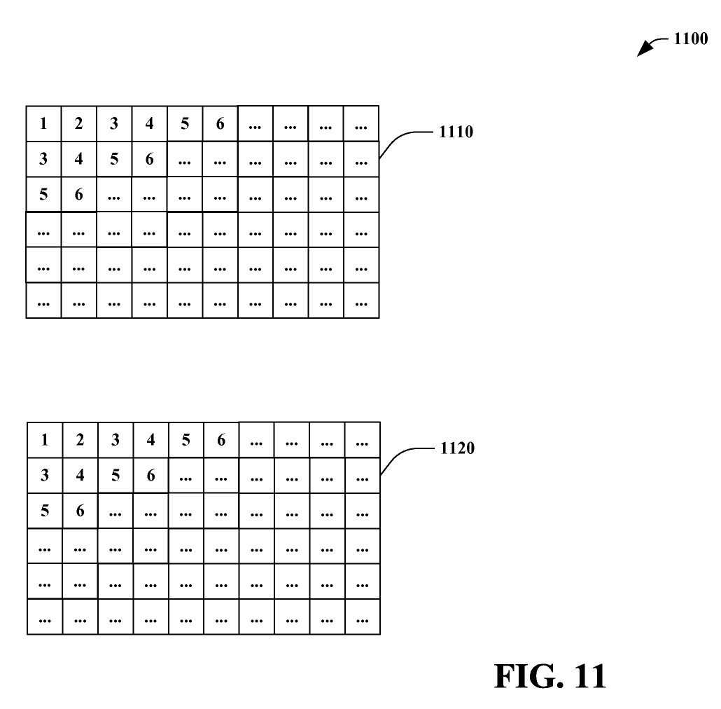

FIG. 10 illustrates an exemplary flow chart 1000 for combining block lists created by slicing a video frame, in accordance with an embodiment of the invention. A slice, or a group of macroblocks, can be decoded independently because blocks of different slices are independent of each other. In one embodiment, a list of m independent block lists can be created based on m slices of a video frame. By combining the m independent block lists together, parallel processing can be facilitated as illustrated by FIG. 11, discussed infra. Referring now to FIG. 10, a video frame can be received for encoding at 1002. At 1004, the video frame can be separated based on slicing the video frame one or more times. One or more block lists, created as a result of the slicing of the video frame, can include a plurality of blocks. At 1006, the one or more block lists can be combined into one or more block sets. At 1008, the plurality of blocks of each block set can be ordered for parallel encoding of a subset of the blocks of each block set. The encoding can depend on one or more adjacent encoded blocks. Further, the subset of the blocks of each block set can be concurrently encoded according to the one or more adjacent blocks at 1010. By combining block lists into one or more block sets, parallel processing of multiple slices can be facilitated, allowing for more optimal use of computing resources and reducing the amount of block information transmitted across a given bandwidth.

FIG. 11 illustrates an example portion of a video frame 1100 comprised of block lists 1110 and 1120 created by slicing the video frame, in accordance with an embodiment of the invention. Because similarly numbered blocks are independent of each other, they can be processed in parallel—thus, as illustrated by FIG. 11, block lists 1110 and 1120 of different slices can be processed at the same time by, e.g., by utilizing GPU computational resources.

As used herein, the terms “component,” “system,” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include, but are not limited to, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, it should be appreciated that a carrier wave can be employed to carry computer-readable electronic data such as those used in transmitting and receiving electronic mail, or in accessing a network such as the Internet or a local area network (LAN). Of course, those skilled in the art will recognize many modifications may be made to this configuration without departing from the scope or spirit of the claimed subject matter.

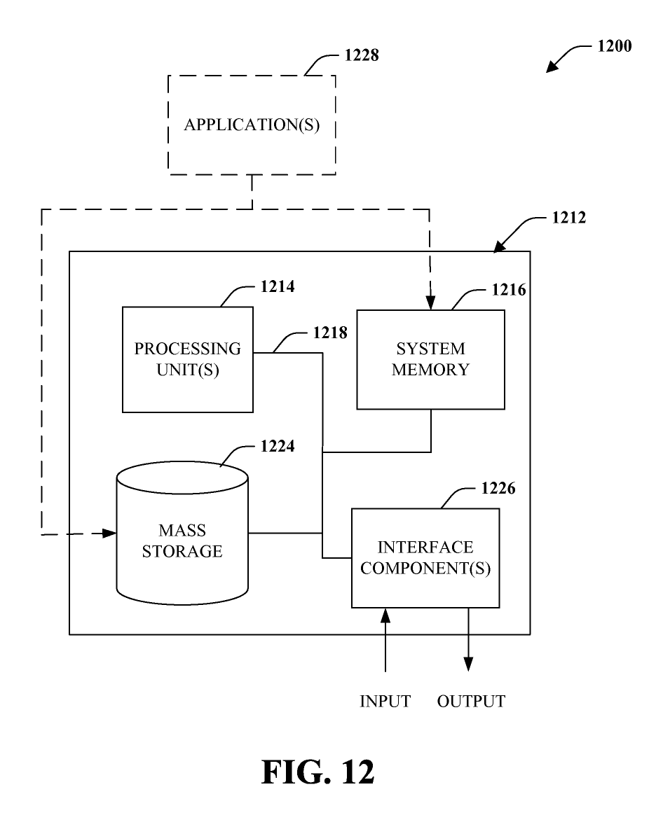

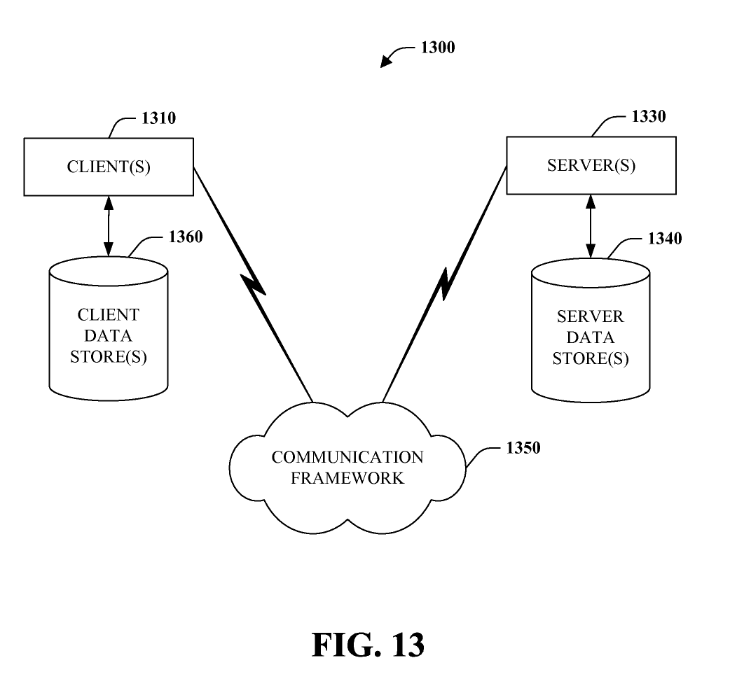

In order to provide a context for the various aspects of the disclosed subject matter, FIGS. 12 and 13, as well as the following discussion, are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types.

Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 12, an exemplary environment 1200 for implementing various aspects disclosed herein includes a computer 1212 (e.g., desktop, laptop, server, hand held, programmable consumer or industrial electronics . . . ). The computer 1212 includes a processing unit 1214, a system memory 1216 and a system bus 1218. The system bus 1218 couples system components including, but not limited to, the system memory 1216 to the processing unit 1214. The processing unit 1214 can be any of various available microprocessors. It is to be appreciated that dual microprocessors, multi-core and other multiprocessor architectures, such as a CPU and/or GPU, can be employed as the processing unit 1214.

The system memory 1216 includes volatile and nonvolatile memory. The basic input/output system (BIOS), containing the basic routines to transfer information between elements within the computer 1212, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1212 also includes removable/non-removable, volatile/non-volatile computer storage media. FIG. 12 illustrates, for example, mass storage 1224. Mass storage 1224 includes, but is not limited to, devices like a magnetic or optical disk drive, floppy disk drive, flash memory or memory stick. In addition, mass storage 1224 can include storage media separately or in combination with other storage media.

FIG. 12 provides software application(s) 1228 that act as an intermediary between users and/or other computers and the basic computer resources described in suitable operating environment 1200. Such software application(s) 1228 include one or both of system and application software. System software can include an operating system, which can be stored on mass storage 1224, that acts to control and allocate resources of the computer system 1212. Application software takes advantage of the management of resources by system software through program modules and data stored on either or both of system memory 1216 and mass storage 1224.

The computer 1212 also includes one or more interface components 1226 that are communicatively coupled to the bus 1218 and facilitate interaction with the computer 1212. By way of example, the interface component 1226 can be a port (e.g., serial, parallel, PCMCIA, USB, FireWire . . . ) or an interface card (e.g., sound, video, network . . . ) or the like. The interface component 1226 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1212 to output device(s) via interface component 1226. Output devices can include displays (e.g., CRT, LCD, plasma . . . ), speakers, printers and other computers, among other things. Moreover, the interface component 1226 can have an independent processor, such as a GPU on a graphics card, which can be utilized to perform functionalities described herein as shown supra.

FIG. 13 is a schematic block diagram of a sample-computing environment 1300 with which the subject innovation can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the aspects of the subject innovation, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. Here, the client(s) 1310 can correspond to program application components and the server(s) 1330 can provide the functionality of the interface and optionally the storage system, as previously described. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

By way of example, one or more clients 1310 can request media content, which can be a video for example, from the one or more servers 1330 via communication framework 1350. The servers 1330 can encode the video using the functionalities described herein, such as block parallel fast motion estimation, encode blocks of the video as related to a reference frame, and store the encoded content in server data store(s) 1340. Subsequently, the server(s) 1330 can transmit the data to the client(s) 1310 utilizing the communication framework 1350, for example. The client(s) 1310 can decode the data according to one or more formats, such as H.264/AVC or other MPEG level decoding, utilizing the encoded motion vector or residue information to decode frames of the media. Alternatively or additionally, the client(s) 1310 can store a portion of the received content within client data store(s) 1360.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “has” or “having,” or variations in form thereof are used in either the detailed description or the claims, such terms are intended to be inclusive in a manner similar to the term “comprising” as “comprising” is interpreted when employed as a transitional word in a claim.

What is claimed is:

1. A computer implemented system comprising a memory having stored therein the following computer executable components:
a multiple reference frame component that loads a plurality of copies of a block list of a reference frame into texture memory;
a block ordering component that specifies an order for encoding a plurality of blocks of a video frame, wherein at least one portion of the plurality of blocks of the video frame are ordered for concurrent encoding; and
a motion estimation component that concurrently determines motion vectors related to each copy of the plurality of copies of the block list of the reference frame, wherein the motion vectors are concurrently determined for the at least one portion of the plurality of blocks of the video frame.

2. The system of claim 1, wherein the motion estimation component comprises a step search component that performs multiple step searches over a plurality of blocks of each copy of the plurality of copies of the block list of the reference frame to determine the motion vectors.

3. The system of claim 2, wherein the step search component utilizes a three step search (TSS), a four step search, a five step search (FSS), or a six step search (SSS) to determine the motion vectors.

4. The system of claim 1, further comprising a video coding component that computes a predicted motion vector for the at least one portion of the plurality of blocks of the video frame based at least in part on one or more adjacent encoded blocks.

5. The system of claim 4, wherein the video coding component encodes the at least one portion of the plurality of blocks of the video frame based at least in part on a cost related to encoding a residue between the predicted motion vector and at least one of the determined motion vectors.

6. The system of claim 5, wherein the at least one portion of the plurality of blocks of the video frame is encoded as the at least one determined motion vector.

7. The system of claim 1, wherein the motion estimation component leverages a graphics processing unit (GPU) to concurrently determine the motion vectors.

8. The system of claim 1, wherein the plurality of blocks are n by m pixels, and wherein n and m are positive integers.

9. A method for concurrently estimating motion in video block encoding, comprising:
separating a video frame utilizing one or more slices to create one or more block lists, wherein the one or more block lists comprise a plurality of blocks;
combining the one or more block lists into one or more block sets;
ordering the plurality of blocks of each block set for parallel encoding of a subset of the blocks of each block set, wherein the parallel encoding depends on one or more adjacent encoded blocks; and
concurrently encoding the subset of blocks according to the one or more adjacent blocks.

10. The method of claim 9, further comprising step searching a plurality of blocks of a reference video frame to determine at least one motion vector for encoding at least one block of the subset of blocks of each block set.

11. The method of claim 10, wherein the step searching includes three step searching (TSS), four step searching, five step searching (FSS), or six step searching (SSS).

12. The method of claim 10, further comprising predicting a motion vector for the at least one block of the subset of blocks of each block set based at least in part on the one or more adjacent encoded blocks.

13. The method of claim 12, wherein the encoding of the subset of blocks of each block set includes encoding at least one block based at least in part on a cost associated with encoding a residue between the predicted motion vector and the determined motion vector.

14. The method of claim 13, wherein the encoding of the subset of blocks of each block set includes encoding at least one block as a motion vector related to the residue.

15. The method of claim 13, wherein the encoding of the subset of blocks of each block set includes encoding at least one block as the determined motion vector.

16. The method of claim 9, wherein the encoding of the subset of blocks of each block set includes encoding the subset of blocks at least partly with a graphics processing unit (GPU) that supports general programming computation (GPGPU).

17. The method of claim 9, wherein the encoding of the subset of blocks of each block set includes encoding blocks with n by m pixels, and wherein n and m are equal or disparate positive integers.

18. A method comprising:
dividing a video frame into one or more block lists, wherein each block list comprises a plurality of blocks;
ordering the plurality of blocks of the one or more block lists to facilitate parallel encoding of at least a subset of the ordered blocks;
loading duplicate block lists associated with a reference frame into texture memory to facilitate parallel encoding of at least the subset of the ordered blocks; and
contemporaneously encoding at least the subset of the ordered blocks based on, at least in part, the duplicate block lists.

19. The method of claim 18, further comprising:
performing a multiple step search over each block list of the duplicate block lists, wherein each block list is associated with one or more blocks of at least the subset of the ordered blocks for computing motion vector information.

20. The method of claim 18, further comprising:
computing a predicted motion vector for one or more blocks of at least the subset of the ordered blocks based on, at least in part, one or more adjacent encoded blocks.
